(19) United States
(12) Patent Application Publication
(10) Pub. No.: US 2005/0100869 A1
(43) Pub. Date: May 12, 2005

(54) Substrate and kit for creating hobby craft item, including craft item produced therefrom

(76) Inventors: Michael Kelly, Liberty Township, OH (US); Danny Estreich, Cincinnati, OH (US)

Correspondence Address: TIMOTHY J MARTIN, PC, 9250 W 5TH AVENUE, SUITE 200, LAKEWOOD, CO, 80226, US

(21) Appl. No.: 10/888,939

(22) Filed: Jul. 8, 2004

Related U.S. Application Data
(60) Provisional application No. 60/485,784, filed on Jul. 8, 2003.

(51) Int. Cl. G09B 11/00

(52) U.S. Cl. 434/81

(57) ABSTRACT

A hobby craft kit provides a substrate which includes a flocked background and at least one design region adapted to receive a flowable color medium. The substrate may be multi-layered and have a working sheet which includes a plurality of discrete design regions organized in a patterned arrangement corresponding to a design to be created, a removable protective layer disposed within each design region, and a flocking surrounding the design regions to define a background for the decorative design. A craft item of a decorative design that is produced by a hobby craft kit is also contemplated.

### BACKGROUND OF THE INVENTION

The present invention relates to craft articles for creating decorative designs on substrates. The present invention more particularly concerns substrates and kits for creating decorative hobby craft articles utilizing colored sand as the application medium.

Children of all ages are intrigued by activities which stimulate their imagination Numerous products are available to foster a child's creativity and help him/her develop craft skills. These products are particularly enjoyed by children who like to create images with crayons, paints or inks. While the artwork created by a child can be rather rudimentary, the skills which can be developed over time simply through repeated exposure to products that stimulate a child's imagination can be indispensable.

A very popular type of kit which has been around for years is known as a paint-by-numbers kit. Here, a child is provided with a black and white reproduction of a multi-colored original picture, with the reproduction divided into outlined segments each identified by a respective number. The child is provided with colored paints, each corresponding to a particular number so that the child can paint within each of the outlined segments in the appropriate color based on the cross-referenced numerical system. In fact, there are many different types of hobby craft kits available which comprise combinations of coloring media, a substrate providing a surface upon which the colors are to be spread in the outline of a design that defines different areas for different colors, and color indicia to instruct the hobbyist with respect to which of the various colors is to be placed in each of the several areas. The coloring media can be crayons, colored markers, or a flowable color bearing medium that is granular in nature (colored sand, colored glitter, etc.) or non-granular in nature (colored paint, colored wax, etc.). One particular type of sand art hobby craft kit is discussed in U.S. Pat. No. 4,169,323, issued Oct. 2, 1979 to Engel. The Engel kit includes a unitary structure having a plurality of substantially transparent tubes for filling with colored sand. There is an outline on the front surface of the structure of a design that defines areas to be colored differently. A base supports the tubes in a vertical position with their upper ends open so that the tubes can be filled with the sand media according to a color indicia chart.

In U.S. Pat. No. 5,141,438 issued Aug. 25, 1992 to Spector, an art craft kit is provided so that a child can reproduce a painting, or other multi-colored artwork printed on a master sheet having a pressure-sensitive adhesive backing. The master sheet is adhered to the face of a blank canvas or other copy sheet. The printed artwork is dissected into stencil segments, the periphery of each segment being defined by a contoured line of perforations. To reproduce the artwork, a child runs a pointed tool along the contoured line defining a selected segment, thereby cutting along the line and separating the segment which is then removed from the master sheet to expose a corresponding blank segment on the copy sheet. Using the removed stencil segment as a guide, the child colors in the blank segment of the copy sheet to match the portion of the artwork appearing on the removed segment. This is repeated until all stencil segments on the master sheet are removed and the artwork is reproduced on the copy sheet.

Other types of hobby craft kits are not subject to patent protection. One such kit is marketed by Kelly's Crafts, Inc. of Ross, Ohio under the mark “Kelly's Sand Painting Fun” and includes a plurality of die-cut designs, a plurality of containers each holding a colored sand, and a color coded sheet for correlating the sand colors to the die-cut designs. Some versions of the kit also include an easel which can be attached to each die-cut design so that it can be propped up on a support surface. Each die-cut design is formed as a substrate that includes a paper layer to which is adhered a peel away liner that is die-cut to outline the various design regions which comprise the overall image or design to be created by the child. Sequentially, the peel away protective layers for each design region are removed to expose a tacky surface underneath that will hold the colored sand in place. The hobbyist then chooses the color of sand that corresponds to the color code for the particular region of interest and pours the sand over the exposed areas of the design. Once the overall picture is completed, it can be supported by the easel, placed in a picture frame, etc. for viewing. Yet another type of kit which is also not subject to patent is marketed by Western Graphics Corp. of Eugene, Oreg. under the registered trademark Fuzzy Posters®. This kit includes a substrate having a design thereon which is defined by a flocked background region, constructed of a black velvet-like texture, and a plurality of white design regions which are un-flocked. A set of coloring markers are included whereby the hobbyist can color the design regions in any desirable color scheme to create a vibrant overall image.

Although there are numerous varieties of hobby craft kits available in the marketplace, including those discussed above, it is desirable to provide a new type of hobby craft kit which combines aspects of the prior art. It is particularly desirable to provide such a kit which utilizes a flowable color material on a flocked, adhering substrate, such that this new and improved craft kit combines aspects employed in the “Kelly's Sand Painting Fun” and Fuzzy Posters® products. The present invention is particularly directed to meeting these needs.

### SUMMARY OF THE INVENTION

It is an object of the present invention to provide a new and improved hobby craft kit that is particularly adapted for use by children of any suitable age.

Another object of the present invention is to provide such a hobby craft kit which allows the hobbyist to create decorative and intricate designs on a substrate utilizing a colored flowable medium, such as sand, colored wax, colored glitter, or the like.

A further object of the present invention is to provide a craft article in the form of a substrate for use in such a hobby craft kit.

Still a further object of the present invention is to provide a craft item created from use of such a kit or substrate.

In accordance with these objections, a hobby craft kit broadly comprises a substrate that includes a flocked background region and at least one design region adapted to receive a flowable color medium, as well as at least one receptacle containing the flowable color medium. The flowable color medium may be granular in nature such as colored sand, glitter, etc., or non-granular in nature such as colored paint, wax, etc. Another embodiment of the hobby craft kit is particular adapted for use in creating a craft item having a decorative design and comprises a plurality of receptacles each containing a flowable medium of a selected color, and a multi-layered substrate. The multi-layered substrate includes a backing adapted to be placed on a flat working surface and a working sheet secured to the backing. The working sheet includes a plurality of discrete design regions organized in a patterned arrangement which corresponds to the decorative design to be created. Each design region has indicia corresponding to a selected color to be placed therein. A protective layer is disposed within each design region and is selectively removable to expose an associated tacky layer adapted to retain the flowable medium therein. A flocking surrounds each one of the design regions to define a flocked background for the decorative design to be created.

Advantageously, each embodiment of the hobby craft kit has a flocked background of a selected flocking color, such as black, which contrasts with the selected color in each of the receptacles. Advantageously also, each design region may include a margin adjacent to the flocked background which is of the same color as the flocking color. Each design region is preferably unflocked and includes a tacky layer, such as one comprised of a suitable adhesive, which is adapted to adhere to the flowable medium. A holder may also be provided for the receptacles and the multi-layered substrate may have it's backing formed of a flexible material such as pressure sensitive paper, or a more rigid material such as corrugated board. The backing can be of any suitable thickness.

The present invention also provides a multi-layered substrate panel for use as a component in a hobby craft kit to create a craft item having a decorative design. The multi-layered substrate panel may be constructed similar to that described above with reference to the second embodiment of the hobby craft kit. Finally, the present invention contemplates a craft item of a decorative design that is produced from such a hobby craft kit. The craft item comprises a substrate panel having a flocked region which defines a background for the decorative design, and at least one unflocked region surrounded by the flocked region and having colored flowable medium retained therein.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of the hobby craft kit of the present invention representatively contained in shrink-wrapped packaging;

FIG. 2 is an top plan view showing various components which comprise the hobby craft kit of FIG. 1;

FIG. 3 is an enlarged partial, cross-sectional view of the hobby craft kit's substrate as viewed about lines 3-3 in FIG. 2;

FIG. 4 is a perspective view of the hobby craft kit's working sheet which forms a part of the substrate shown in FIG. 3, but which may also represent a separate embodiment for the substrate of the present invention.

FIG. 5(a) is a top perspective view of an alternative embodiment of a container for the hobby craft kit; and

FIG. 5(b) is a bottom perspective view of the container shown in FIG. 5(a).

### DETAILED DESCRIPTION OF THE EXEMPLARY EMBODIMENTS

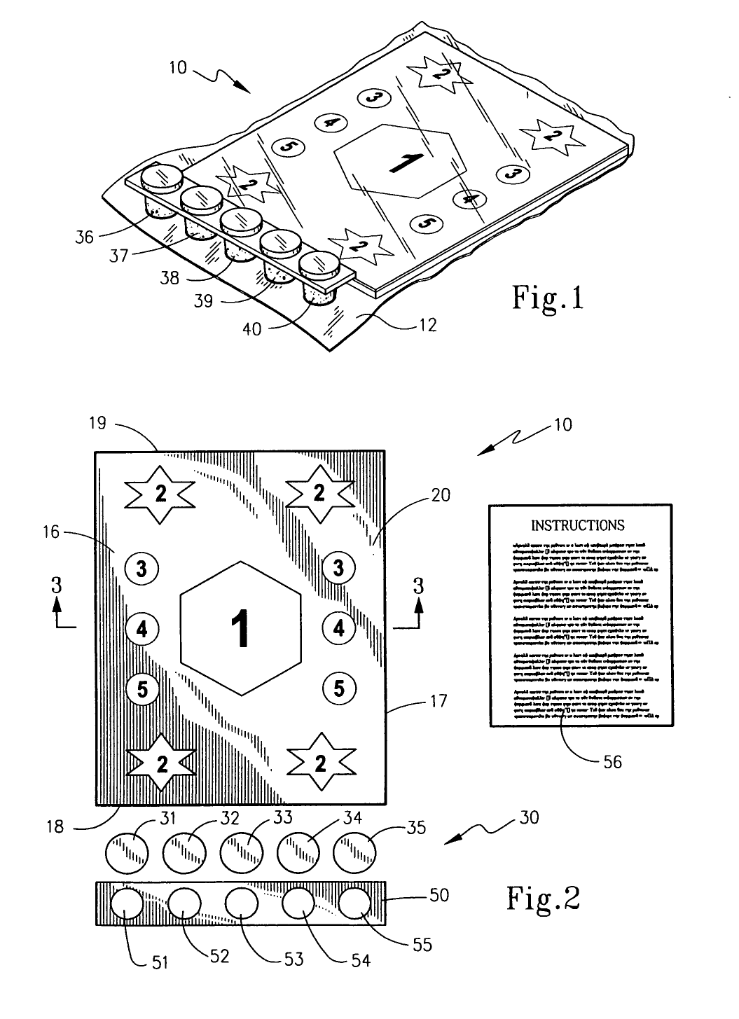

In accordance with these objectives, a representative embodiment of a hobby craft kit 10 according to the present invention is shown in FIGS. 1 and 2. Hobby craft kit 10 comprises a variety of items for a hobbyist, such as a child or person of any suitable age, to create decorative artwork designs for display. The contents of hobby craft kit 10 may be packaged in an appropriate packaging container, such as shrink-wrapped packing 12 shown in FIG. 1, or any other appropriate container, such as a box or the like. As best shown in FIG. 2, the contents of hobby craft kit 10 include a substrate panel 20 that is provided with the design to be created, a set 30 of receptacles which may be in the form of individual plastic containers 31-35, each of which contains a flowable color media. Receptacles 31-35 may be any arbitrary number of lidded containers, as shown However, they could also be in the form of individual bags, a sealed set of blister containers, or any other appropriate construction for holding a flowable medium. For the purposes of the present invention, each of containers 31-35 is, respectively, filled with distinctly colored sands 36-40. Preferably also, where substrate 20 has an overall image that is comprised of a plurality of design regions, such as regions 23-25, each intended to be filled with a particular color of flowable media, there are at least enough different colors of sand within containers 31-35 to suffice. Of course, although the exemplary embodiment of the invention as shown in the figures has a substrate 20 provided with numerical indicia in each of the design regions which correlate to the sand color to be applied, this should not be construed as unduly limiting the invention, as the ordinarily skilled artisan would appreciate that such indicia could alternatively be provided on a separate sheet, or not provided at all.

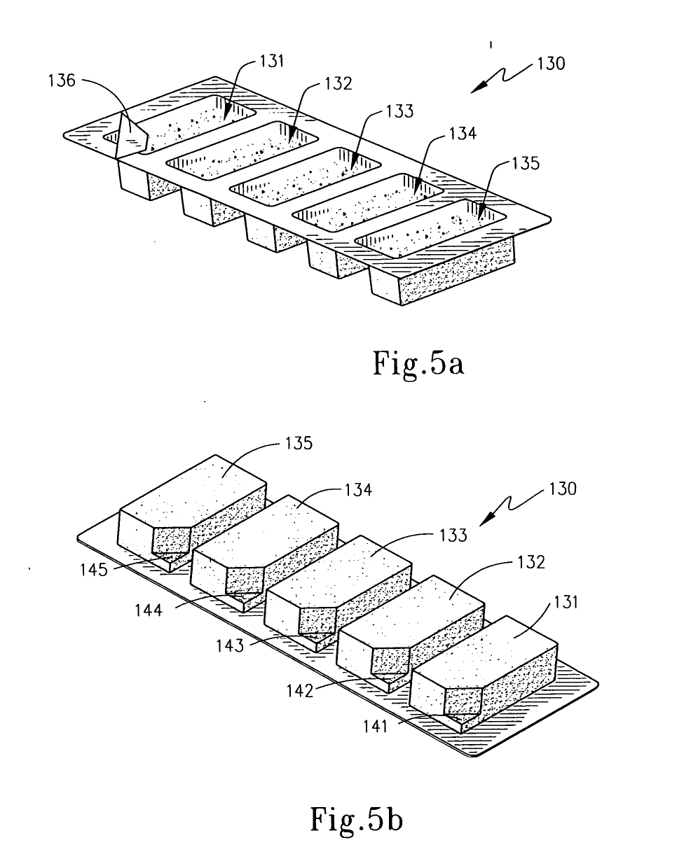

As also shown in FIGS. 1 and 2, hobby craft kit 10 may include a holder 50 in the form of a panel piece having a plurality of circular apertures 51-55 formed therethrough, each for receiving a respective one of the lidded containers 31-35 so the containers can be conveniently organized on a working surface during use of hobby craft kit 10 or conveniently stowed within packaging 12 for display as shown in FIG. 1. An instruction sheet 56 is also preferably provided for the craft kit which, among other things, can contain instructions which cross-reference the numerical indicia in the various design regions of substrate 20 to a particular sand color so that the hobbyist is instructed with respect to which of the several colors of sand is to be placed in each of the design regions. Any suitable holder for the containers could be provided so that FIGS. 1 and 2 are only representative. An alternative container construction is shown in FIGS. 5(a) and 5(b) to be a unitary plastic mold container 130 having a plurality of reservoirs 131-135, each containing a different color of sand. Container 130 is separable by cutting between adjacent ones of reservoirs 131-135 to then create individualized sand containers. As can be seen in FIG. 5(b), each reservoir has a corner region, 141-145 respectively, of reduced depth so that, when the reservoir's blister carder covering layer 136 is peeled away in the corner region, a pouring spout is created for applying the colored sand onto the substrate.

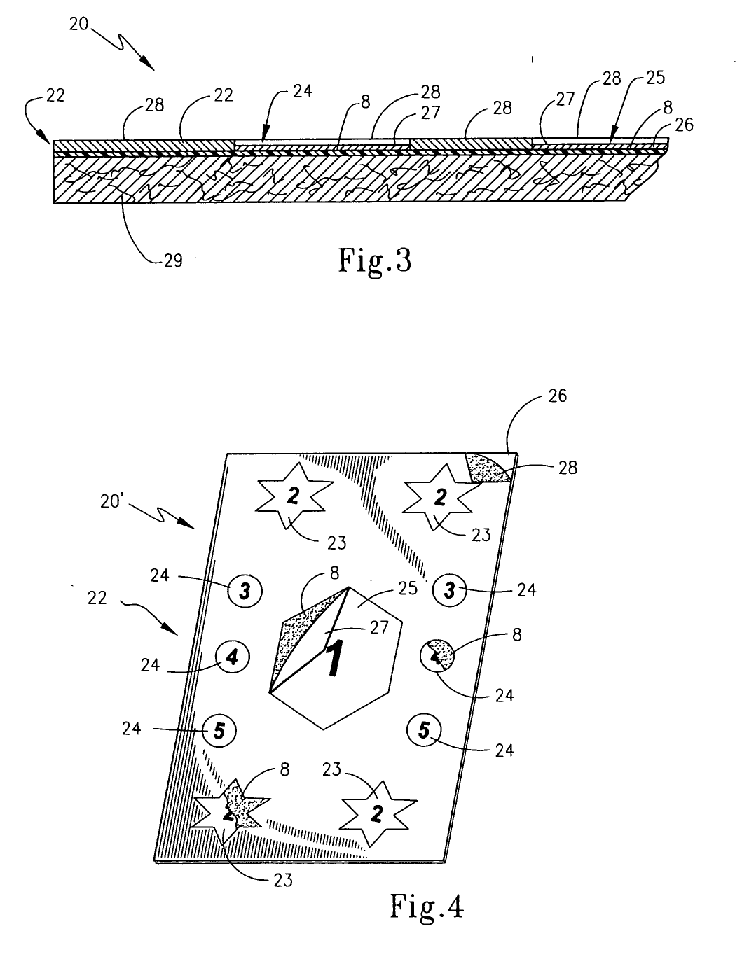

The construction of one possible embodiment for substrate 20 is perhaps best appreciated with reference to FIGS. 2 and 3. Substrate 20 here is a multi-layered rectangular piece such that it has opposed pairs of longitudinal edges 16, 17 and transverse edges 18, 19. Substrate 20 contains a multi-layered, flocked working sheet 22, also shown alone in FIG. 4, which is die-cut into a plurality of discrete design regions, thereby outlining the overall design image to be created. Working sheet 22 may be supported on a more rigid backing 29 if desired. Backing 29 can be corrugated board or other suitable material which serves to rigidify the substrate construction to facilitate working therewith. Backing 29 can also provide some rigidity to the packaging for the hobby craft kit 10 when it is shrink-wrapped. Alternatively, as shown in FIG. 4, a substrate 20′ may be defined by the working sheet 22 alone. In this manner, a backing is formed by flexible sheet 26 which may be pressure sensitive paper, or the like, of a suitable thickness.

In any event, as seen in FIG. 4, a representative overall image is outlined which comprises a plurality of discrete, enclosed design regions. These design regions, for representative purposes only, may include a plurality of stars 23, circles 24 and a hexagonal region 25. Of course, any of a variety of images, each comprising a plurality of design regions, can be presented on working sheet so that the Figures are for illustrative purposes only. Moreover, each of the discrete design regions need not be enclosed since, depending on the overall image to be conveyed, one or more of them could communicate with the edges of working sheet 22.

As shown, flocked working sheet 22 is also is a multi-layered construction having the lower base sheet 26, a peel-away protective liner 27 within each of the respective design regions, and the flocking layer 28 which, as shown in FIG. 4, defines the background of the overall image to be created. If the backing 29 is not provided, this flexible working sheet 22 can simply be used and placed upon an appropriate flat support surface during use.

The skilled artisan should readily appreciate that substrate 20 could be manufactured in a variety of different ways to arrive at the construction shown particularly in FIG. 3. That is, for example, working sheet 22 can be manufactured whereby the flexible sheet 26 is coated with an adhesive 8 that is formed from a suitable release material. A unitary protective layer 27 can then be placed over the entirety of sheet 26 so that it removably covers the adhesive. This intermediate construction can then be die-cut to outline the overall design pattern corresponding to the design image to be created. An outer adhesive can then be applied to the peel-away protective layer 27 in those areas (i.e. the image's background region) where the flocking is to be, so that the protective layer 27 in the discrete design regions, 23-25, has no outer adhesive. This background area can then be flocked through an appropriate flocking process, as known in the art, to generate flocking layer 28 for working sheet 22, after which it can be adhered to backing 29, if desired.

In order for the hobbyist to create the overall design image, then, the hobbyist can sequentially remove the peel-away protective layer 27 in each of those regions of the overall design which are to be filled with sand of a particular color. For example, as shown in FIG. 4, the hexagonal design region 25 has its associated protective layer 27 identified by the numeral 1 which would correspond to a particular sand color, such as blue. The hobbyist would initially remove layer 27 to expose the tacky adhesive substance 8 and pour the blue colored sand into region 25. Once this is accomplished, and the excess sand is removed, the hobbyist can then repeat the same process with respect to each remaining design region which is to be filled with a particular color. Thus, in FIG. 4, it may be appreciated that, next, the hobbyist could remove the protective layers associated with each of the star regions 23 and fill them with a suitable sand color. This process would be repeated until the overall design is completed. A suitable background color for the flocking material 28 is black so that the completed image has a very vibrant appearance by virtue of the black background and the colorful sands which fill each design region.

Where the peel-away protective layer 27 throughout the working sheet is of a light color, or a color different than the flocking layer 28, it may also be desirable during the manufacturing process to print on this protective layer along the borders of each of the respective design regions 23-25, a margin having a color which corresponds to that of the flocking layer 28. This prevents any white background of the protective layer 27 showing through in the event there is mis-registration during the flocking process. That way, if the hobbyist does not completely fill the crevices of the design regions 23-25 with the colored sand, colored wax, or any other appropriate flowable medium which is used, these uncovered areas become essentially indiscernible when the design is completed because they are printed to blend with the flocked regions.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A hobby craft kit, comprising:
(a) a substrate including a flocked background and at least one design region adapted to receive a flowable color medium; and
(b) at least one receptacle containing the flowable color medium.

2. A hobby craft kit according to claim 1 wherein the flowable color medium is selected from a group consisting of colored sand, colored glitter, colored paint and colored wax.

3. A hobby craft kit according to claim 1 including a plurality of design regions organized as a patterned arrangement corresponding to a design image to be created, and a plurality of receptacles each containing a flowable medium of a selected color.

4. A hobby craft kit according to claim 3 wherein each of said design regions is unflocked.

5. A hobby craft kit according to claim 3 wherein each of said design regions includes a tacky layer adapted to adhere to the flowable medium.

6. A hobby craft kit according to claim 3 wherein each of said design regions is provided with indicia correlated to a selected color to be placed therein from a respective one of said receptacles.

7. A hobby craft kit according to claim 1 wherein said flocked background is of a selected flocking color, and wherein said design region includes a surrounding margin adjacent to said flocked background which is of a same color as said flocking color.

8. A hobby craft kit according to claim 1 wherein said flocking color is black.

9. A hobby craft kit according to claim 3 wherein said flocked background is of a selected flocking color which contrasts with the selected color in each of said receptacles, and wherein each of said design regions includes a printed margin adjacent to said flocked background which is of a same print color as said flocking color.

10. A hobby craft kit for use in creating a craft item having a decorative design, comprising:
(a) a plurality of receptacles each containing a flowable medium of a selected color;
(b) a multi-layered substrate having a working sheet which includes:
(i) a plurality of discrete design regions organized in a patterned arrangement which corresponds to the decorative design to be created, each design region having indicia corresponding to a selected color to be placed therein;
(ii) a protective layer disposed within each design region and being selectively removable to expose an associated tacky layer adapted to retain the flowable medium therein; and
(iii) flocking surrounding each one of said design regions to define a flocked background for the decorative design to be created.

11. A hobby craft kit according to claim 10 including instructions correlating the indicia within each design region to the selected color of flowable medium to be placed therein.

12. A hobby craft kit according to claim 10 including a holder for said receptacles.

13. A hobby craft kit according to claim 10 wherein the flowable medium within each of said receptacles is selected from a group consisting of colored sand, colored glitter, colored paint and colored wax colored sand.

14. A hobby craft kit according to claim 10 wherein said flocked background is of a selected flocking color which contrasts with the selected color in each of said receptacles, and wherein each of said design regions includes a printed margin adjacent to said flocked background which is of a same print color as said flocking color.

15. A hobby craft kit according to claim 10 wherein said multi-layered substrate further includes a backing selected from one of a flexible construction and a rigidifying construction.

16. A multi-layered substrate panel for use as a component in a hobby craft kit to create a craft item having a decorative design, said substrate panel comprising a working sheet which includes a backing adapted to be placed on a flat working surface, said working sheet including:
(a) a plurality of discrete design regions organized in a patterned arrangement which corresponds to the decorative design to be created;
(b) a protective layer disposed within each design region and being selectively removable to expose an associated tacky layer adapted to retain the flowable medium therein; and
(c) flocking surrounding each one of said design regions to define a flocked background for the decorative design to be created.

17. A multi-layered substrate according to claim 16 wherein each design region has indicia corresponding to a selected color to be placed therein.

18. A multi-layered substrate according to claim 16 wherein said flocked background is black, and wherein each of said design regions includes a black printed margin adjacent to said flocked background.

19. A craft item of a decorative design produce with a hobby craft kit, said craft item comprising,
(a) substrate panel having:
(i) a flocked region which defines a background for the decorative design; and
(ii) at least one unflocked region surrounded by said flocked region and having a flowable medium retained therein that is selected from a group consisting of colored sand, colored glitter, colored paint and colored wax.
